(19) United States
(12) Patent Application Publication
(10) Pub. No.: US 2006/0155903 A1
(43) Pub. Date: Jul. 13, 2006

(54) Resource management device

(75) Inventors: Yuki Soga, Kyoto (JP); Takahide Baba, Hyogo (JP); Yuji Takai, Osaka (JP); Daisuke Murakami, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/285,021

(22) Filed: Nov. 23, 2005

(30) Foreign Application Priority Data
Jan. 13, 2005 (JP) 2005-006273

(51) Int. Cl. G06F 13/14

(52) U.S. Cl. 710/240

(57) ABSTRACT

A bus arbitration part for arbitrating access requests from bus masters includes an arbitration history management section that records absence of an access request from any bus master at a given basic arbitration timing. Based on this record, an access request arbitration section issues access permission for an access request issued after the given basic arbitration timing without a wait for the next basic arbitration timing.

### BACKGROUND OF THE INVENTION

The present invention relates to a resource management device, used in a system in which a plurality of masters issue requests for access to at least one shared resource, for arbitrating such access requests from the masters to the shared resource.

Inside a system LSI, a plurality of masters, such as a microprocessor, a digital signal processor (DSP) and a direct memory access (DMA) controller, make access to shared resources such as a memory and a peripheral input/output (I/O) controller. In this situation, it is necessary to provide a resource management device for arbitrating access requests from the masters to the shared resources efficiently.

In some prior art, a resource management device arbitrates access requests at every fixed time interval based on priority information of masters given in advance in the form of a table. The table includes a plurality of patterns of priority information, and the patterns are sequentially selected at every fixed time interval of the arbitration. Each master is allowed to receive access permission by the number of times equal to the number of patterns that assign the highest priority to the master, so that the minimum access bandwidth is guaranteed for each master (see US 2004/0073730 A1).

In a system in which requests for access to a shared resource are arbitrated at fixed time intervals as that described above, if a temporal clustering arises in the timing of occurrence of an access request from a master, no access permission will be issued to any master at an arbitration timing at which no access request exists, resulting in discarding a chance of granting access permission. As a result, a number of access requests may cluster at another arbitration timing. In such a case, the access latency of a master having a low priority will increase.

### SUMMARY OF THE INVENTION

An object of the present invention is improving the access efficiency and the access latency in a system in which requests for access to a shared resource are arbitrated at fixed time intervals.

To attain the above object, according to the present invention, while arbitration of access requests from masters to a shared resource is being made at basic arbitration timings with fixed intervals, the timing of start of arbitration operation can be shifted from the basic timing according to a history of the arbitration status.

To state specifically, an arbitration history management section records failure in issuing access permission due to absence of an access request from any master at a given basic arbitration timing (permission postponing record) if any, and the access permission is issued to a master who has issued an access request after the given basic arbitration timing independently of the basic timing.

In addition, if the system has enough performance to spare, access permission may be issued to a certain master that has issued an access request even immediately after issuance of access permission to another master at a basic arbitration timing, without a wait for the next basic arbitration timing. The arbitration history management section records this issuance of access permission (permission advancing record).

Preferably, a postponing upper limit may be set to impose limitation on the cumulative number of permission postponing records, and an advancing upper limit may be set to impose limitation on the cumulative number of permission advancing records.

### BRIEF DESCRIPTION OF THE DRAWINGS

FIG. 1 is a block diagram of a resource management device of Embodiment 1 of the present invention.

FIG. 2 shows an example of arbitration information in the form of a table held in an arbitration information management section in FIG. 1.

FIG. 3 is a block diagram illustrating an arbitration timing control section in FIG. 1 in detail.

FIG. 4 is a flowchart showing an example of operation of a bus arbitration part in FIG. 1.

FIG. 5 is a timing chart showing access permission timing observed when the flow of FIG. 4 is followed.

FIG. 6 is a flowchart showing another example of operation of the bus arbitration part in FIG. 1.

FIG. 7 is a timing chart showing access permission timing observed when the flow of FIG. 6 is followed.

FIG. 8 is a block diagram of a resource management device of Embodiment 2 of the present invention.

FIG. 9 is a block diagram illustrating an arbitration timing control section in FIG. 8 in detail.

FIG. 10 is a flowchart showing an example of operation of a bus arbitration part in FIG. 8.

FIG. 11 is a timing chart showing access permission timing observed when the flow of FIG. 10 is followed in which the upper limit of a history counter is set.

FIG. 12 is a timing chart showing access permission timing observed when the flow of FIG. 10 is followed in which the lower limit of the history counter is set.

FIG. 13 is a flowchart showing another example of operation of the bus arbitration part in FIG. 8.

FIG. 14 is a block diagram of a resource management device of Embodiment 3 of the present invention.

FIG. 15 is a flowchart showing an example of operation of a history setting information management section in FIG. 14.

FIG. 16 is a block diagram of a resource management device of Embodiment 4 of the present invention.

FIG. 17 is a block diagram illustrating an arbitration timing control section and an arbitrary history management section in FIG. 16 in detail.

FIG. 18 is a flowchart showing an example of operation of a bus arbitration part in FIG. 16.

FIG. 19 is a flowchart showing details of counting-up processing in FIG. 18.

FIG. 20 is a flowchart showing details of first counting-down processing in FIG. 18.

FIG. 21 is a flowchart showing details of second counting-down processing in FIG. 18.

### DESCRIPTION OF THE PREFERRED EMBODIMENTS

Hereinafter, preferred embodiments of the present invention will be described with reference to the accompanying drawings. In the following description, each bus master is supposed to have a function of actively outputting an address signal, a control signal and the like for data access. In general, one functional block has a plurality of interfaces for bus connections, some of which work as bus masters and some others as bus slaves. A processor of Harvard architecture, for example, has bus masters for instructions and bus masters for data.

### Embodiment 1

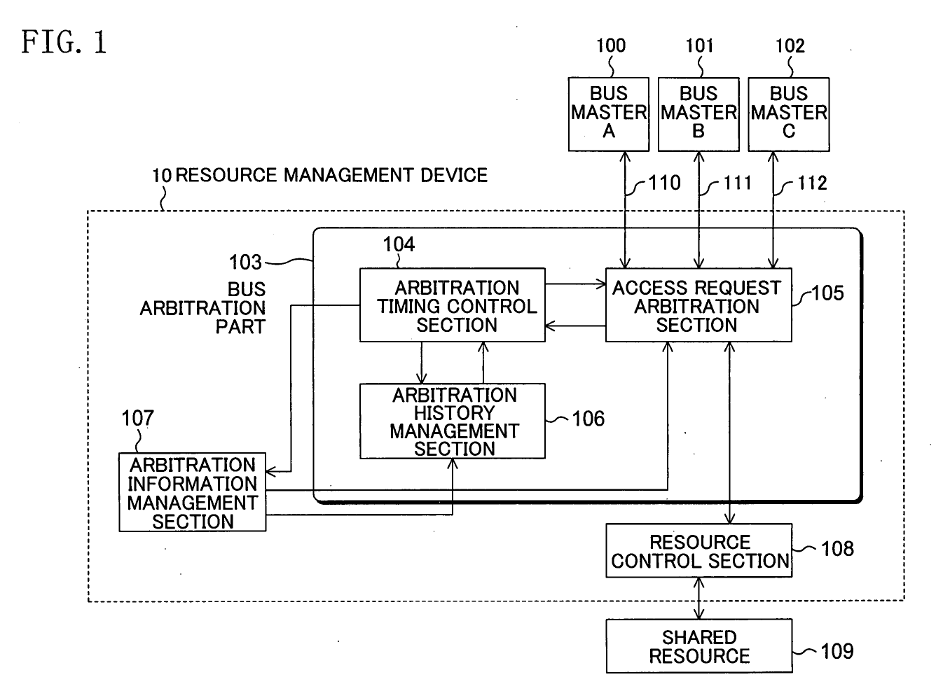

FIG. 1 illustrates a configuration of a resource management device 10 of Embodiment 1 of the present invention. The resource management device 10 of FIG. 1, interposed between three bus masters 100, 101 and 102 and a shared resource 109, includes a bus arbitration part 103, an arbitration information management section 107 and a resource control section 108. The bus arbitration part 103 is essentially composed of an arbitration timing control section 104, an access request arbitration section 105 and an arbitration history management section 106. The bus masters 100, 101 and 102 are connected to the access request arbitration section 105 of the bus arbitration part 103 via buses 110, 111 and 112, respectively. In the following description, the bus masters 100, 101 and 102 are also called bus masters A, B and C, respectively, as appropriate.

The bus arbitration part 103 arbitrates access requests issued by the bus masters 100 to 102 at arbitrary timings, based on priority information of the bus masters 100 to 102 held in the arbitration information management section 107, and notifies the resource control section 108 of an access request selected as a result of this arbitration. The resource control section 108 controls data transfer between the bus master selected by the bus arbitration part 103 and the shared resource 109.

In the bus arbitration part 103, the arbitration timing control section 104 outputs an arbitration timing signal to the access request arbitration section 105 and the arbitration information management section 107 based on history information from the arbitration history management section 106 and a signal indicating presence/absence of an access request sent from the access request arbitration section 105. The arbitration timing signal supplied to the arbitration information management section 107 is used to designate a pattern of priority information. The access request arbitration section 105 arbitrates access requests from the bus masters 100 to 102 based on the priority information sent from the arbitration information management section 107, and sends the access request from the selected bus master to the resource control section 108. The access request arbitration section 105 also controls data transfer between the selected bus master and the resource control section 108. The arbitration history management section 106 records an arbitration history in response to a history control signal from the arbitration timing control section 104. Also, the arbitration history management section 106 can initialize the arbitration history in response to an arbitration period signal from the arbitration information management section 107.

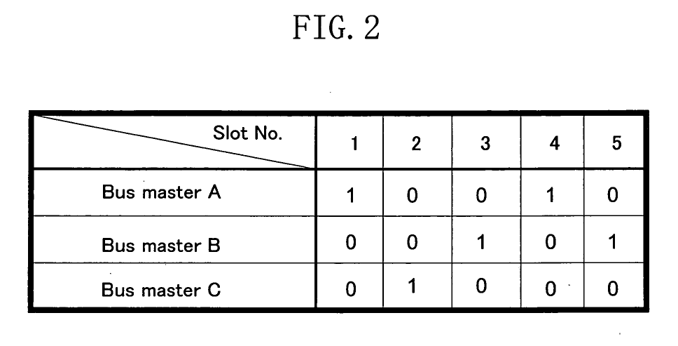

FIG. 2 shows an example of the arbitration information held in the arbitration information management section 107 in the form of a table. In the table of FIG. 2, the leftmost column represents the fixed priority order among the bus masters A, B and C with the top having the highest priority. Each of the other five columns indicates which one of the bus masters A, B and C wins the highest priority with the bus master having “1” winning the highest priority. The highest priority in each column takes precedence over the fixed priority order in the leftmost column. The fixed priority order is used only when there is no access request from the bus master winning the highest priority. These five columns are called “slots” having their “slot numbers” given in the uppermost row. The number of the slot used for the output of the priority information to the access request arbitration section 105 is updated at every fixed time interval sequentially from 1 to 5 and then back to 1.

According to the table of FIG. 2, each of the bus masters A, B and C is allowed to receive access permission by the number of times equal to the number of slots that assign “1” to the bus master in one cycle of slots. Specifically, the bus masters A, B and C are granted access permission at a rate of two to five, a rate of two to five and a rate of one to five, respectively. This indicates that each of the bus masters A and B can acquire 40% of the entire bandwidth, while the bus master C can acquire 20% of the entire bandwidth. For the respective bus masters A, B and C, therefore, their minimum access bandwidths are guaranteed. In this sense, the period defined by the table of FIG. 2 is called a “bandwidth guarantee period”.

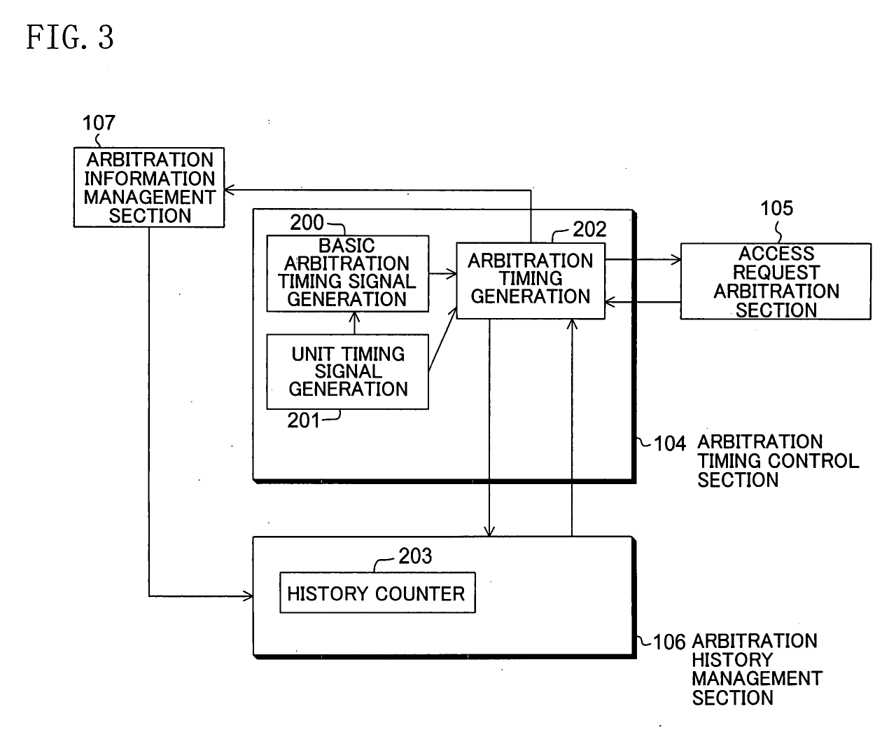

FIG. 3 illustrates a detailed configuration of the arbitration timing control section 104 in FIG. 1. The arbitration timing control section 104 includes three blocks of basic arbitration timing signal generation 200, unit timing signal generation 201 and arbitration timing generation 202. The unit timing signal generation block 201 outputs a unit timing signal, representing the minimum time intervals at which access permission is granted to bus masters, to the basic arbitration timing signal generation block 200 and the arbitration timing generation block 202. The unit timing signal is generated based on a clock signal (not shown) input externally, in which one clock cycle or a plurality of clock cycles is adopted as the unit time. The unit timing signal generation block 201 will be unnecessary if one clock cycle is adopted as the unit time. The basic arbitration timing signal generation block 200 outputs a basic arbitration timing signal, representing arbitration timings of fixed time intervals that serve as the basis for the arbitration, to the arbitration timing generation block 202, based on the unit timing signal from the unit timing signal generation block 201. The basic arbitration timing signal is generated every unit time or every plural unit times. The arbitration timing generation block 202 generates an arbitration timing signal based on the unit timing signal from the unit timing signal generation block 201, the basic arbitration timing signal from the basic arbitration timing signal generation block 200, the history information from the arbitration history management section 106 and the signal indicating presence/absence of an access request from a bus master sent from the access request arbitration section 105, and outputs the generated arbitration timing signal to the access request arbitration section 105 and the arbitration information management section 107. The arbitration timing generation block 202 also generates the history control signal to be given to the arbitration history management section 106.

In the illustration of FIG. 3, the arbitration history management section 106 records an arbitration history by use of a history counter 203. The history counter 203 is incremented/decremented in response to the history control signal from the arbitration timing generation block 202, and is initialized in response to the arbitration period signal from the arbitration information management section 107. The value of the history counter 203 is sent to the arbitration timing generation block 202 as the history information to be used for generation of the arbitration timing signal.

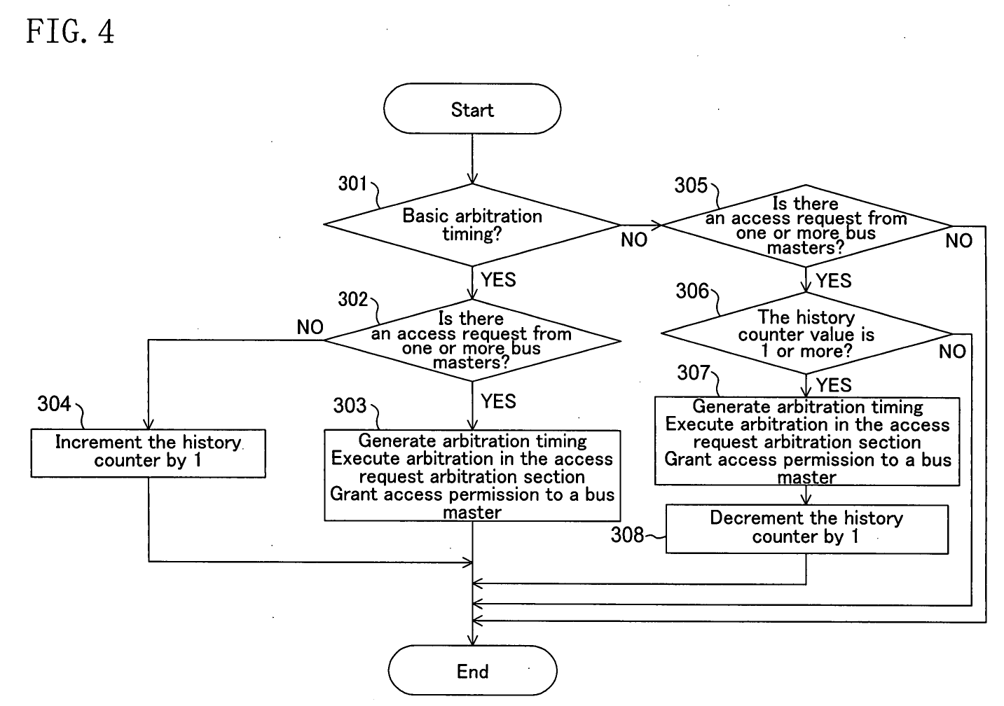

FIG. 4 shows an example of operation of the bus arbitration part 103 in FIG. 1. Assume in the following description that the initial value of the history counter 203 is 0.

The bus arbitration part 103 completes the operation shown in FIG. 4 for each unit time notified by the unit timing signal generation block 201. In step 301, the arbitration timing generation block 202 determines whether or not the operating timing is a basic arbitration timing notified by the basic arbitration timing signal generation block 200. If it is a basic arbitration timing, the process proceeds to step 302. Otherwise, the process proceeds to step 305. In the step 302, the arbitration timing generation block 202 determines whether or not there exists an access request from one or more bus masters based on the signal from the access request arbitration section 105. If there exists an access request, the process proceeds to step 303. Otherwise, the process proceeds to step 304. In the step 303, the arbitration timing generation block 202 generates the arbitration timing signal, to instruct the access request arbitration section 105 to execute arbitration. As a result, any of the bus masters 100 to 102 is granted access permission according to the priority information shown in FIG. 2. In the step 304, the value of the history counter 203 is incremented by one, to thereby record lack of issuing access permission due to absence of an access request at the basic arbitration timing as a permission postponing record.

In the step 305, the arbitration timing generation block 202 determines whether or not there exists an access request from one or more bus masters based on the signal from the access request arbitration section 105. If no access request exists, the process is terminated. If there exists an access request, the process proceeds to step 306. In the step 306, the arbitration timing generation block 202 examines whether or not the value of the history counter 203 is 1 or more, to determine whether or not there is a basic arbitration timing at which no access permission has been issued to any bus master. If the history counter 203 is 1 or more, the process proceeds to step 307. If the history counter 203 is 0, the process is terminated. In the step 307, as in the step 303, the arbitration timing generation block 202 generates the arbitration timing signal, to instruct the access request arbitration section 105 to execute arbitration. The process then proceeds to step 308, in which the value of the history counter 203 is decremented by one to thereby delete one permission postponing record. The process is then terminated.

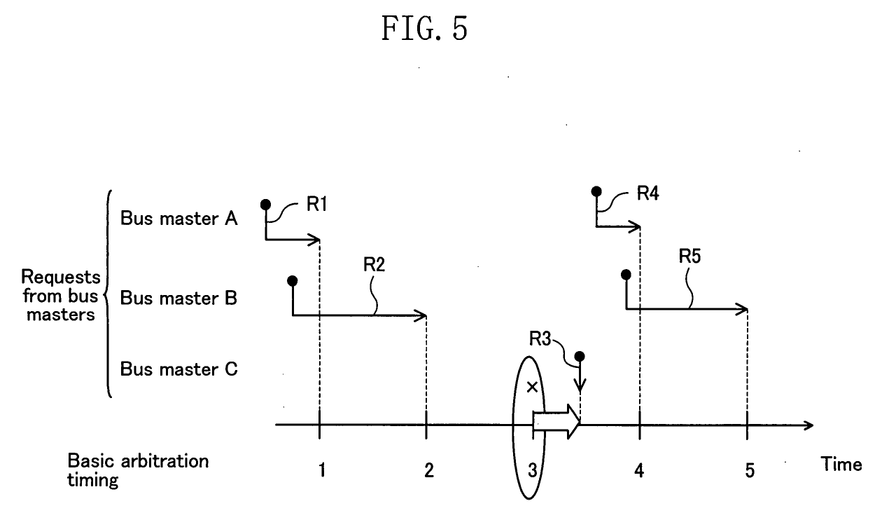

FIG. 5 shows access permission timing observed when the flow of FIG. 4 is followed. The basic arbitration timings 1 to 5 in FIG. 5 respectively correspond to the slots 1 to 5 in FIG. 2. R1 and R4 represent access requests from the bus master A, R2 and R5 represent access requests from the bus master B, and R3 represents an access request from the bus master C. In FIG. 5, each of the access requests R1 to R5 is shown as an arrow, in which the black point represents the timing of issuance of the access request by the bus master A, B or C, and the tip of the arrow represents the timing of issuance of access permission. At the basic arbitration timings 1, 2, 4 and 5, access permission is issued by following the steps 301, 302 and 303. However, at the basic arbitration timing 3, no access request from any bus master exists (marked x in FIG. 5), and in this case, permission postponing is recorded in the history counter 203 by following the step 304. Once the access request R3 is issued by the bus master C after the basic arbitration timing 3, access permission is immediately issued and then the permission postponing record in the history counter 203 is deleted, by following the steps 305, 306, 307 and 308. In this way, the arbitration chance left unused at the basic arbitration timing 3 can be used without being discarded (see the hollow arrow in FIG. 5). In addition, the latency until issuance of access permission for the access request R3 from the bus master C can be shortened.

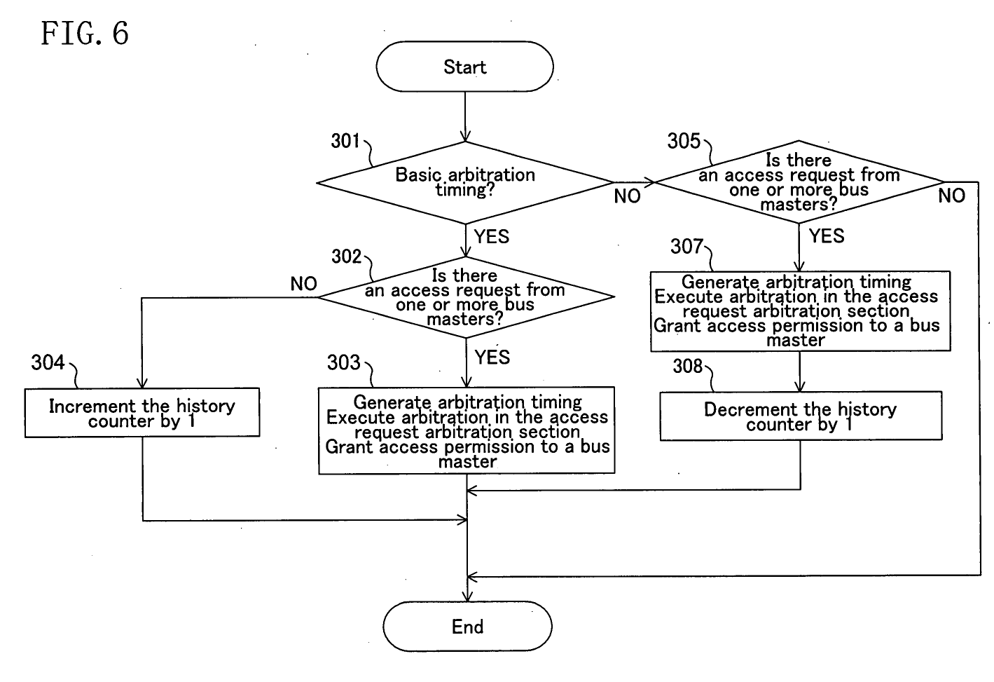

FIG. 6 shows another example of operation of the bus arbitration part 103 in FIG. 1. The difference of this flow from the flow of FIG. 4 is that the restriction in the step 306 in FIG. 4 is removed and the value of the history counter 203 can be negative.

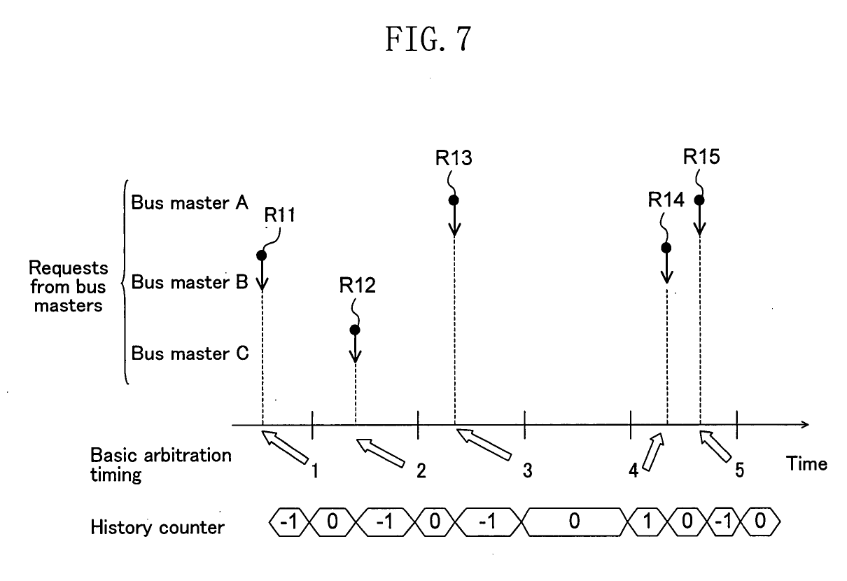

FIG. 7 shows access permission timing observed when the flow of FIG. 6 is followed. R13 and R15 represent access requests from the bus master A, R11 and R14 represent access requests from the bus master B, and R12 represents an access request from the bus master C. When the access request R11 is issued by the bus master B, access permission for this request is issued in advance without a wait for the basic arbitration timing 1 by following the steps 305, 307 and 308, and the value of the history counter 203 is decremented by one, which will then be “−1”. Thereafter, at the basic arbitration timing 1, the value of the history counter 203 is incremented by one by following the steps 301, 302 and 304. This handling also applies to the access requests R12, R13 and R15. Access permission can be issued without a wait for a basic arbitration timing by allowing a negative value for the history counter 203, and in this way, access latency can be improved. For the access request R14 from the bus master B, lack of issuing access permission at the basic arbitration timing 4 is recorded (permission postponing record) and thereafter access permission is issued.

The value of the history counter 203 can be initialized to 0 every bandwidth guarantee period or every plural bandwidth guarantee periods using the arbitration period signal sent from the arbitration information management section 107 to the arbitration history management section 106 (see FIGS. 1 and 3), to thereby prevent loss of accuracy in bandwidth guarantee due to accumulation of the history over the long term.

### Embodiment 2

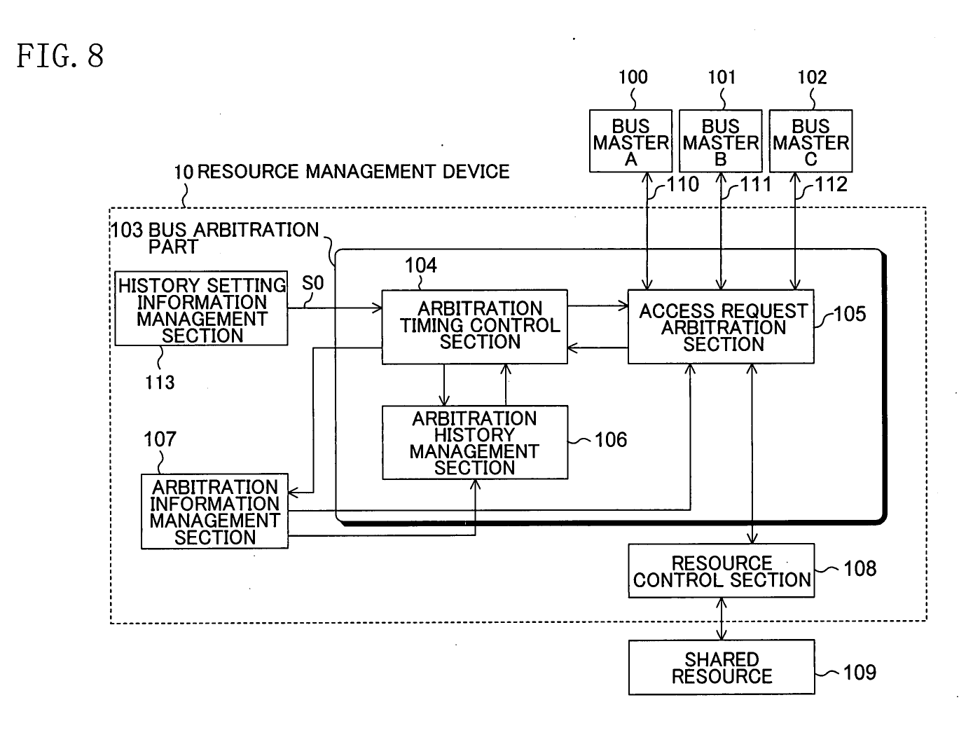

FIG. 8 illustrates a configuration of a resource management device of Embodiment 2 of the present invention. The resource management device of this embodiment includes a history setting information management section 113 in addition to the components of the resource management device of FIG. 1. The history setting information management section 113 holds various types of setting information for the operation of the arbitration timing control section 104 and supplies a determination control signal S0 to the arbitration timing control section 104.

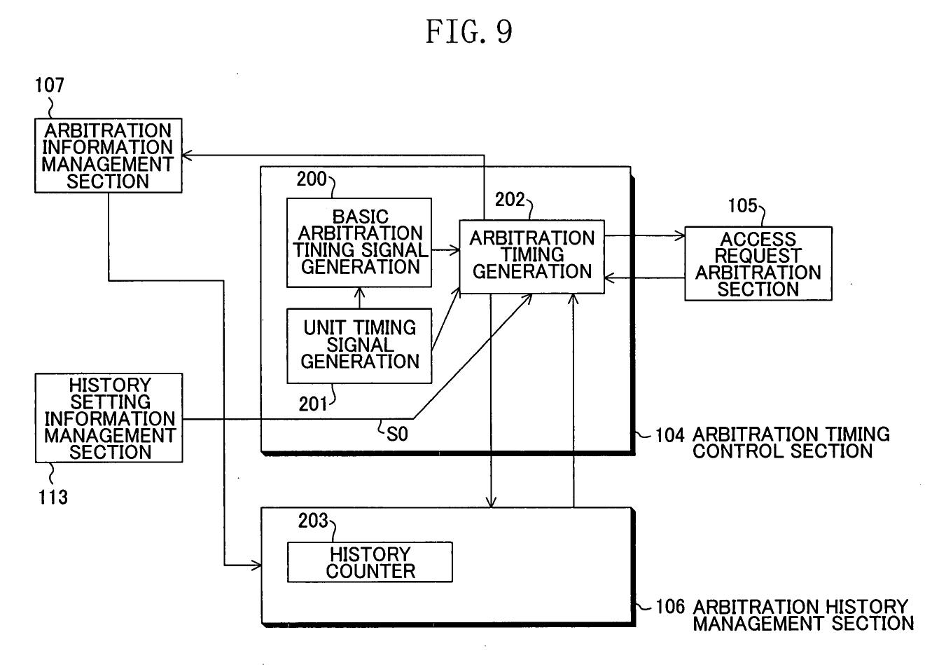

FIG. 9 illustrates a detailed configuration of the arbitration timing control section 104 in FIG. 8. The determination control signal S0 from the history setting information management section 113 is input into the arbitration timing generation block 202, which determines its operation according to the received determination control signal S0.

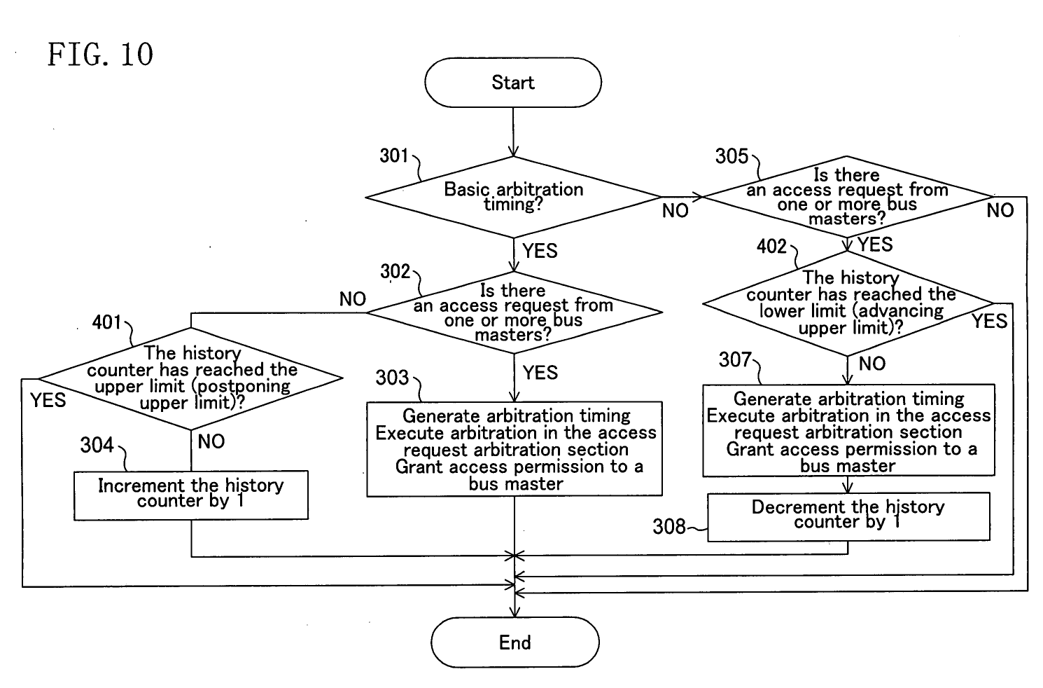

FIG. 10 shows an example of operation of the bus arbitration part 103 in FIG. 8 to be followed when the upper and lower limits allowed for the history counter 203 are set in the history setting information management section 113. Assume in the following description that the initial value of the history counter 203 is 0.

The bus arbitration part 103 executes the operation shown in FIG. 10 for each unit time informed by a unit time timing signal generation block 201. In step 301, the arbitration timing generation block 202 determines whether or not the operating timing is a basic arbitration timing informed by the basic arbitration timing signal generation block 200. If it is a basic arbitration timing, the process proceeds to step 302. Otherwise, the process proceeds to step 305. In the step 302, the arbitration timing generation block 202 determines whether or not there exists an access request from one or more bus masters based on the signal from the access request arbitration section 105. If there exists an access request, the process proceeds to step 303. Otherwise, the process proceeds to step 401. In the step 303, the arbitration timing generation block 202 issues the arbitration timing signal, to instruct the access request arbitration section 105 to execute arbitration. As a result, any of the bus masters 100 to 102 is granted access permission according to the priority information shown in FIG. 2. In the step 401, the arbitration timing generation block 202 compares the current value of the history counter 203 with the upper limit (postponing upper limit) for the history counter 203 sent from the history setting information management section 113 as the determination control signal S0. If the current value has not reached the upper value, the process proceeds to step 304. If the current value has reached the upper value, the process is terminated. In the step 304, the value of the history counter 203 is incremented by one.

In the step 305, the arbitration timing generation block 202 determines whether or not there exists an access request from one or more bus masters based on the signal from the access request arbitration section 105. If no access request exists, the process is terminated. If there exists an access request, the process proceeds to step 402. In the step 402, the arbitration timing generation block 202 determines whether or not the current value of the history counter 203 is larger than the lower limit (advancing upper limit) for the history counter 203 sent from the history setting information management section 113 as the determination control signal S0. If the current value has reached the lower limit, the process is terminated. If the current value has not reached the lower limit, the process proceeds to step 307. In the step 307, as in the step 303, the arbitration timing generation block 202 issues the arbitration timing signal, to instruct the access request arbitration section 105 to execute arbitration. The process then proceeds to step 308, in which the value of the history counter 203 is decremented by one. The process is then terminated.

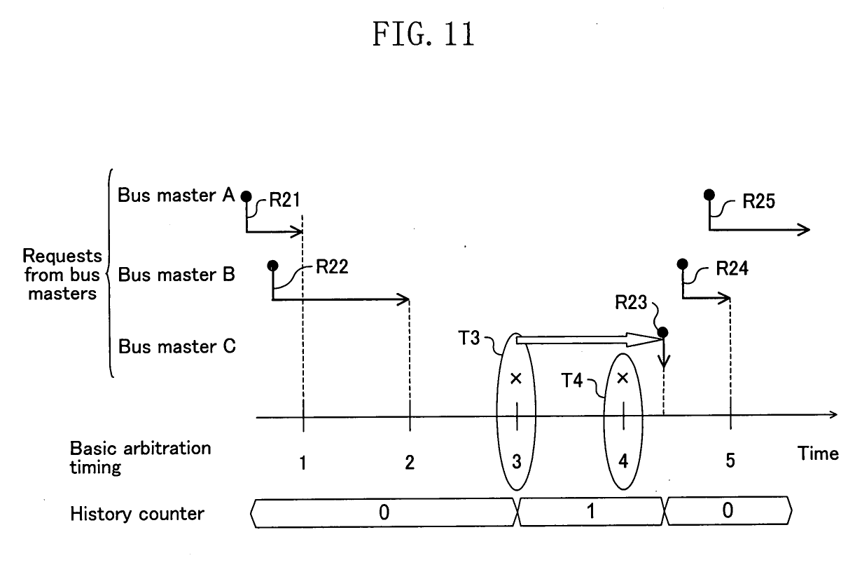

FIG. 11 shows access permission timing observed when the flow of FIG. 10 is followed and the upper limit of the history counter 203 is set at “1”. R21 and R25 represent access requests from the bus master A, R22 and R24 represent access requests from the bus master B, and R23 represents an access request from the bus master C. At the basic arbitration timing 3, at which no access request is issued from any bus master (see T3), the value of the history counter 203 is incremented by one in the step 304, to record lack of issuing access permission at the basic arbitration timing 3. The value of the history counter 203 then becomes “1”. No access request exists, either, at the next basic arbitration timing 4 (see T4). However, since the value of the history counter 203 has already reached the upper limit “1”, control is made not to increase the value of the history counter 203 in the step 401. In other words, restriction is made not to record the lack of issuing access permission at the basic arbitration timing 4. The access permission postponed at the basic arbitration timing 3 is issued for the access request R23 issued after the basic arbitration timing 4.

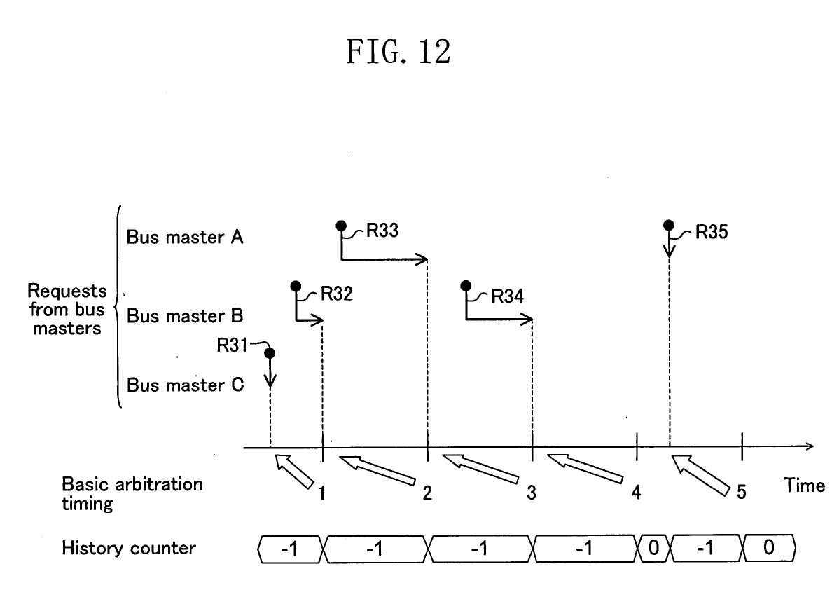

FIG. 12 shows access permission timing observed when the flow of FIG. 10 is followed and the lower limit of the history counter 203 is set at “−1”. R33 and R35 represent access requests from the bus master A, R32 and R34 represent access requests from the bus master B, and R31 represents an access request from the bus master C. For the access request R31 issued by the bus master C before the basic arbitration timing 1, access permission is immediately issued while the value of the history counter 203 is decremented by one, by following the steps 305, 402, 307 and 308. That is, access permission that should have been issued at the basic arbitration timing 1 was issued in advance, and thus the value of the history counter 203 becomes “−1”. For the next access request R32 from the bus master B, also, the determination in the step 305 is “YES”, and thus the process attempts to proceed to the processing of issuing access permission (step 307). At this time, however, since the value of the history counter 203 has already reached the lower limit “−1”, no access permission is issued immediately for the access request R32 (step 402). At the basic arbitration timing 1, at which the access request R32 from the bus master B is left unaccepted, access permission for this request is issued by following the steps 301 to 303. At this time, the value of the history counter 203 remains “−1”, and it is regarded that access permission to be issued at the basic arbitration timing 2 was issued in advance for the access request R32 at the basic arbitration timing 1. Access permission for the subsequent access requests R33 to R35 are also issued in similar ways although description thereof is omitted.

Thus, as described above with reference to FIGS. 10 to 12, by imposing limits on the value of the history counter 203, clustering of issuance of access permission is prevented, and thus excessive load on the resource control section 108 can be prevented. For example, when the resource control section 108 has a buffer for holding commands such as addresses from the bus masters and data to be transferred, the upper and lower limits of the history counter 203 can be set in consideration of the data processing performance of the resource control section 108 and the downstream shared resource 109. By setting in this way, occurrence of buffer overflowing and accumulation of an excessive amount of data can be prevented. Only one of the upper and lower limits of the history counter 203 may be selectively set according to the natures of the resource control section 108 and the shared resource 109.

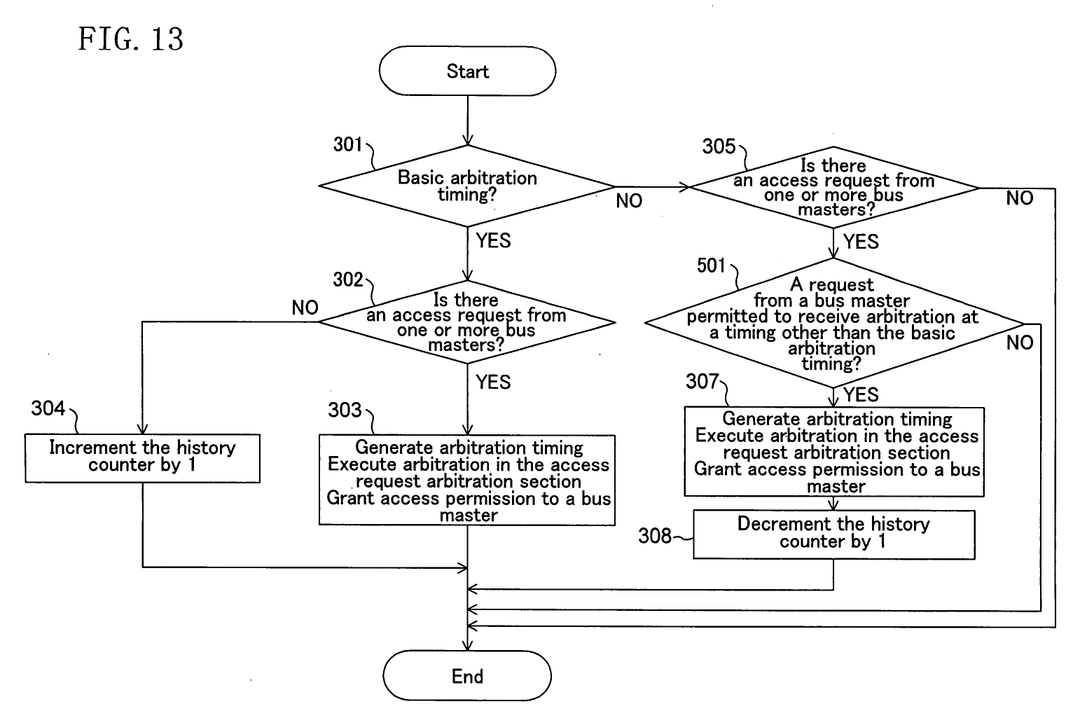

FIG. 13 shows another example of operation of the bus arbitration part 103 in FIG. 8 to be followed when whether or not each of the bus masters 100 to 102 is a master permitted to obtain access permission at an timing other than the basic arbitration timings is set in the history setting information management section 113. In step 501 in FIG. 13, control is made to issue access permission only for a master permitted to obtain access permission at an timing other than the basic arbitration timings, according to the information held in the history setting information management section 113. For example, by prohibiting issuance of access permission to a bus master low in fixed priority order at an timing other than the basic arbitration timings, it is possible to prevent reduction in the number of times of issuance of access permission to a bus master high in fixed priority order. To implement such access permission restriction imposed on individual bus masters, the arbitration timing generation block 202 notifies the access request arbitration section 105 of an arbitration-prohibited bus master, if any, in addition to the notification of the arbitration timing.

### Embodiment 3

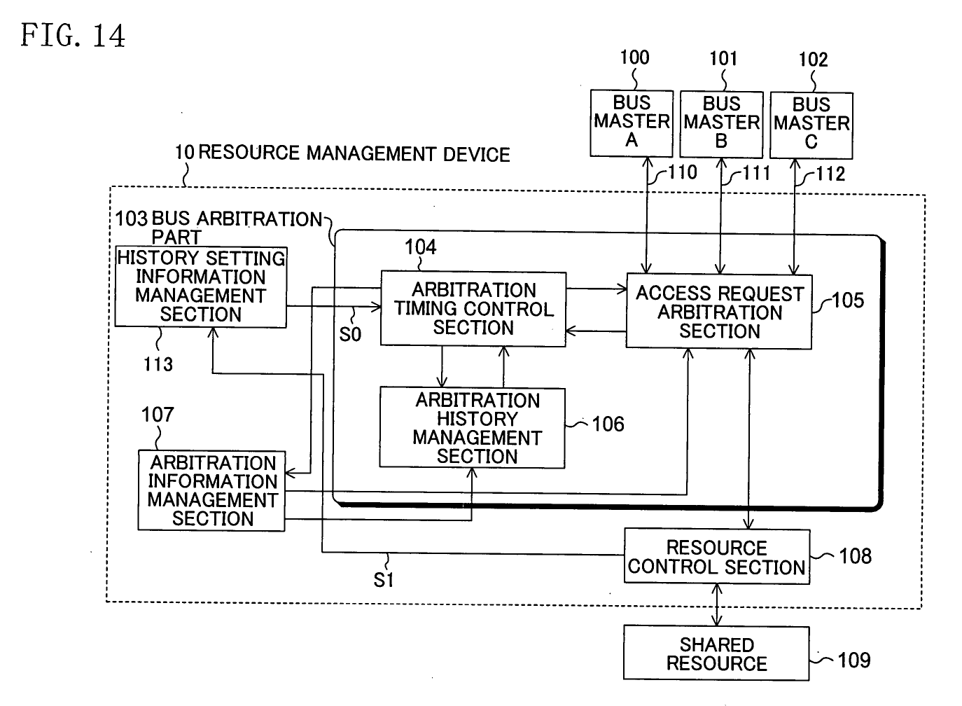

FIG. 14 shows a configuration of a resource management device of Embodiment 3 of the present invention. The resource management device of this embodiment is different from the resource management device of FIG. 8 in that a resource status signal S1 indicating the internal status of the resource control section 108 or the shared resource 109 is sent from the resource control section 108 to the history setting information management section 113. The history setting information management section 113 dynamically changes various items of setting information based on the resource status signal S1.

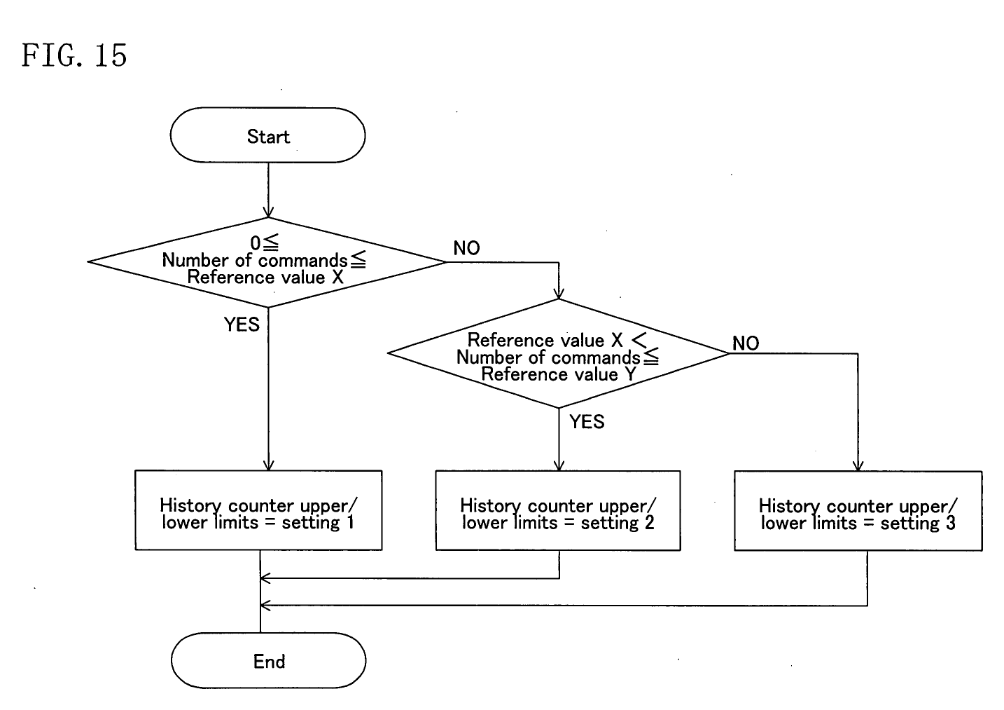

FIG. 15 shows an example of operation of the history setting information management section 113 in FIG. 14. It is herein assumed that the resource control section 108 has a first-in, first-out (FIFO) buffer for holding commands representing access requests from the bus masters 100 to 102. The FIFO buffer sequentially holds access request commands from the bus masters 100 to 102 granted access permission and outputs the held commands to the shared resource 109.

Referring to FIG. 15, the resource control section 108 notifies the history setting information management section 113 of the number of commands in the FIFO buffer as the resource status signal S1. The history setting information management section 113, which holds reference values X and Y and a setting information group selected based on the reference values X and Y, compares the number of commands in the FIFO buffer notified by the resource control section 108 with the reference values X and Y, selects the upper and lower limits of the history counter 203 according to the comparison results, and outputs the selected upper and lower limits to the arbitration timing control section 104 as the determination control signal S0. Specifically, as the number of commands in the FIFO buffer is greater, the upper limit of the history counter 203 is made smaller or the lower limit thereof is made greater, to thereby reduce the frequency of issuance of access permission at timings other than the basic arbitration timings. In other words, limitations can be imposed on the value of the history counter 203 according to the processing performance of the resource control section 108 and the shared resource 109, and thus the arbitration timing control section 104 can issue the arbitration timing signal responsive to the processing performance of the resource control section 108 and the shared resource 109.

In the example of FIG. 15, one set of upper and lower limits was selected based on the two reference values X and Y Alternatively, an arbitrary number of reference values may be used. Also, the reference values for the upper limit may be made different from those for the lower limit.

In the change of the limits of the history counter 203, there may be a case that the value of the history counter 203 at the time of the change is greater than a new limit. In such a case, the new limit can be taken as the value of the history counter 203. Alternatively, the value of the history counter 203 at the time of the change may be held without change. Also, the setting of whether or not each of the bus masters 100 to 102 be a master permitted to obtain access permission at an timing other than the basic arbitration timings may be made dynamically changeable according to the status of the resource control section 108 or the shared resource 109.

### Embodiment 4

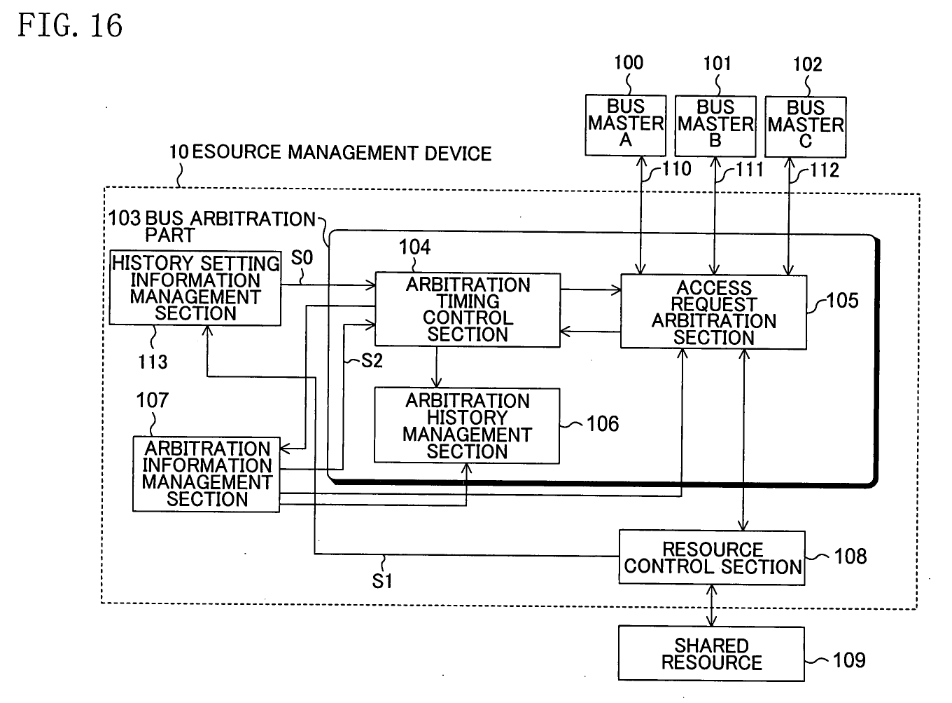

FIG. 16 shows a configuration of a resource management device of Embodiment 4 of the present invention. In this embodiment, the arbitration history management section 106 has a history counter for each bus master, and a highest priority signal S2 indicating to which bus master the highest priority is currently assigned is sent from the arbitration information management section 107 to the arbitration timing control section 104.

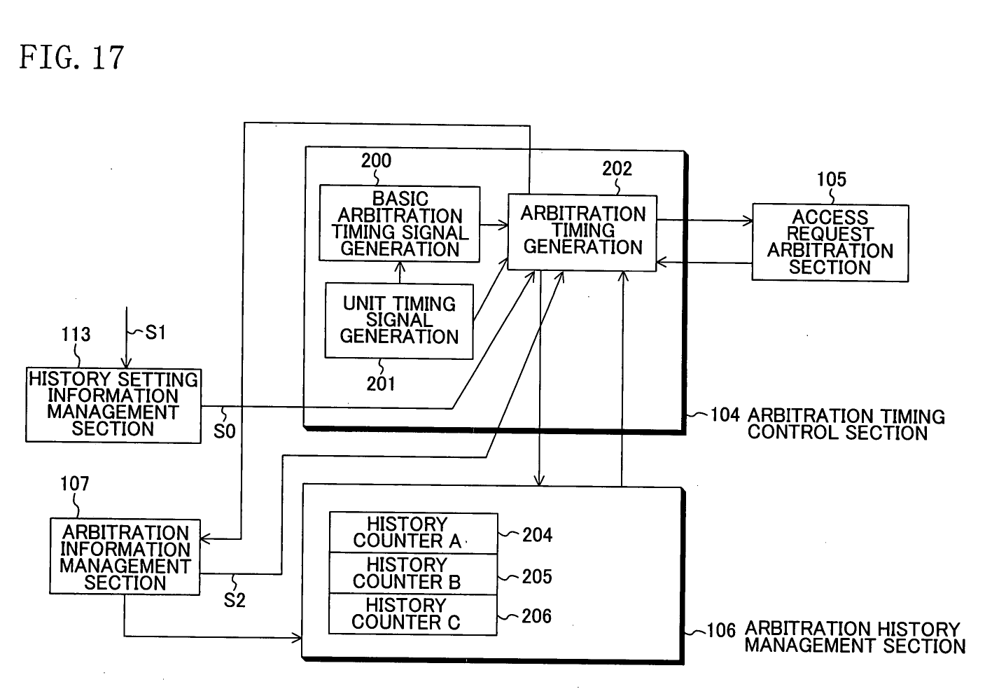

FIG. 17 shows a detailed configuration of the arbitration timing control section 104 and the arbitration history management section 106. The arbitration history management section 106 has history counters (A, B and C) 204, 205 and 206 for the respective bus masters. The arbitration information management section 107, managing the priority information under the table shown in FIG. 2, sends the highest priority signal S2 to the arbitration timing generation block 202. The arbitration timing generation block 202 outputs individual history control signals to the arbitration history management section 106 for controlling the history counters 204 to 206 for the respective bus masters. The access request arbitration section 105 sends a signal indicating to which bus master access permission has been issued, in addition to the signal indicating presence/absence of an access request, to the arbitration timing generation block 202. Also, to impose limitation on access permission for the respective bus masters according to the values of the history counters 204 to 206, the arbitration timing generation block 202 sends a notification of an arbitration-prohibited bus master, in addition to the notification of arbitration timing, to the access request arbitration section 105.

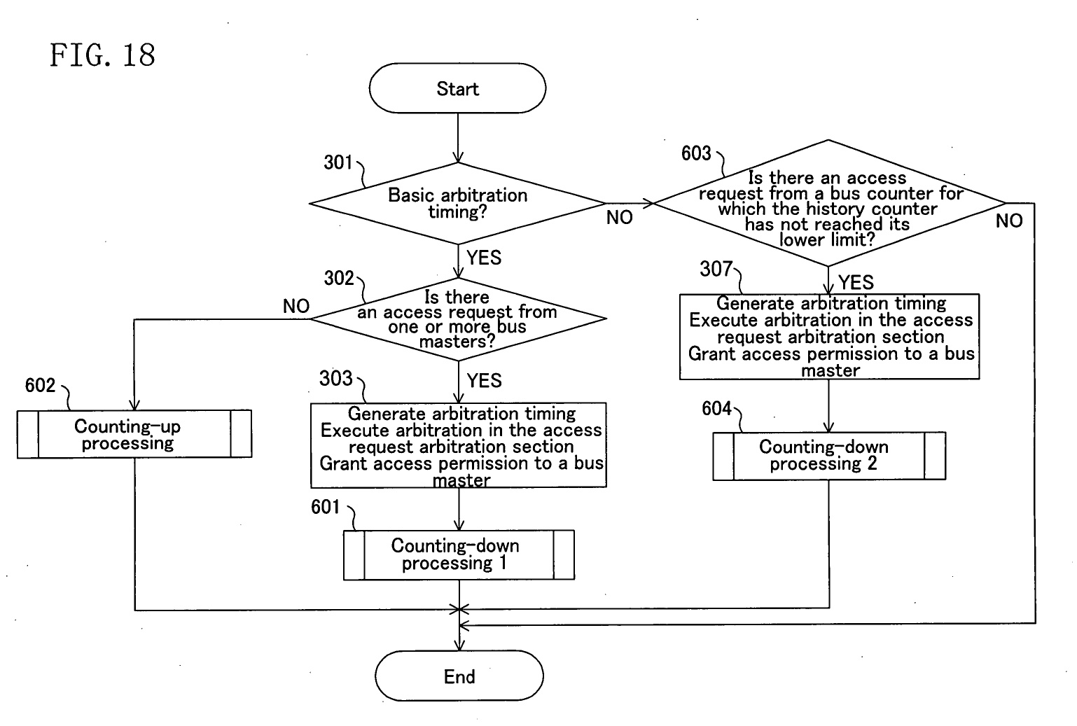

FIG. 18 shows an example of operation of the bus arbitration part 103 in FIG. 16. Assume in the following description that the initial values of the history counters 204 to 206 are all 0.

The bus arbitration part 103 executes the operation shown in FIG. 18 for each unit time notified by the unit timing signal generation block 201. In step 301, the arbitration timing generation block 202 determines whether or not the operating timing is a basic arbitration timing notified by the basic arbitration timing signal generation block 200. If it is a basic arbitration timing, the process proceeds to step 302. Otherwise, the process proceeds to step 603. In the step 302, the arbitration timing generation block 202 determines whether or not there exists an access request from one or more bus masters based on the signal from the access request arbitration section 105. If there exists an access request, the process proceeds to step 303. Otherwise, the process proceeds to step 602.

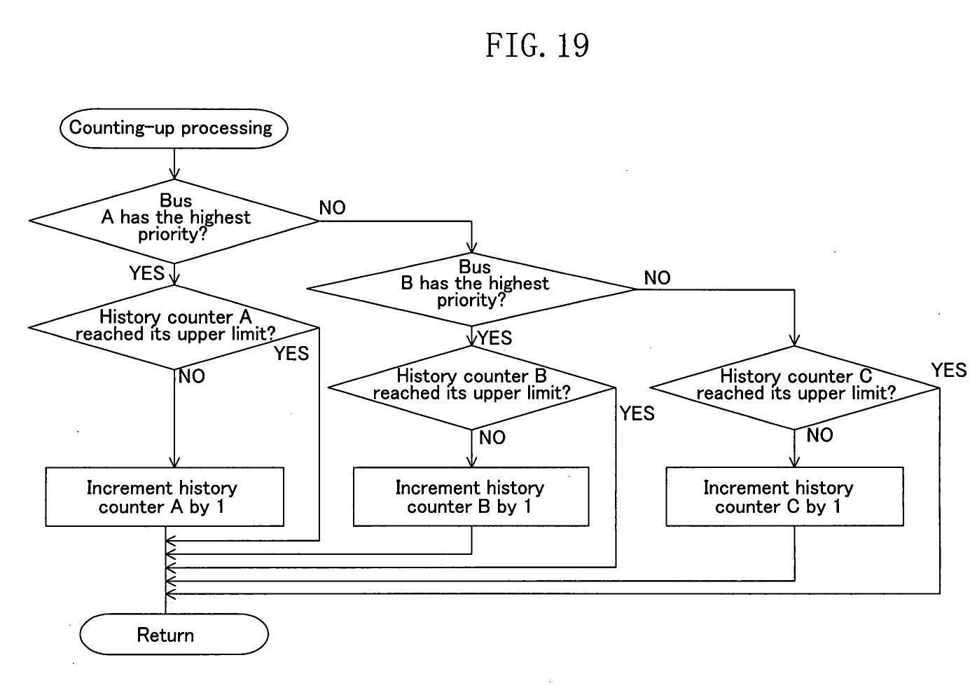

In the step 602, the history counters 204 to 206 are subjected to counting-up processing. In the counting-up processing, shown in FIG. 19 in detail, the value of the history counter for the bus master to which the highest priority has been assigned, among the history counters 204 to 206, is incremented by one, based on the highest priority signal S2 from the arbitration information management section 107. In incrementing the value of any of the history counters 204 to 206, reference should be made to the counter upper limit given from the history setting information management section 113, to ensure not to increment the counter value if the counter value has reached its upper limit.

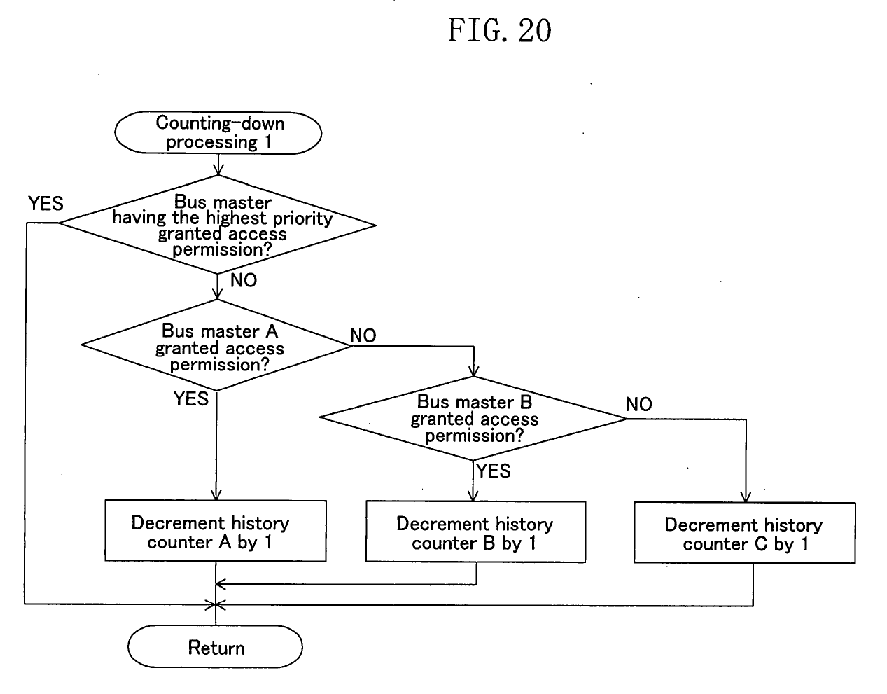

In the step 303 in FIG. 18, the arbitration timing generation block 202 generates the arbitration timing signal, to instruct the access request arbitration section 105 to execute arbitration. As a result, any of the bus masters 100 to 102 is granted access permission according to the priority information shown in FIG. 2. The process then proceeds to step 601. In the step 601, the history counters 204 to 206 are subjected to first counting-down processing. In the first counting-down processing, shown in FIG. 20 in detail, the arbitration timing generation block 202 first determines whether or not the bus master granted access permission is the bus master having the highest priority. If it is the bus master having the highest priority, this processing is terminated. Otherwise, the value of the history counter for the bus master granted access permission, among the history counters 204 to 206, is decremented by one.

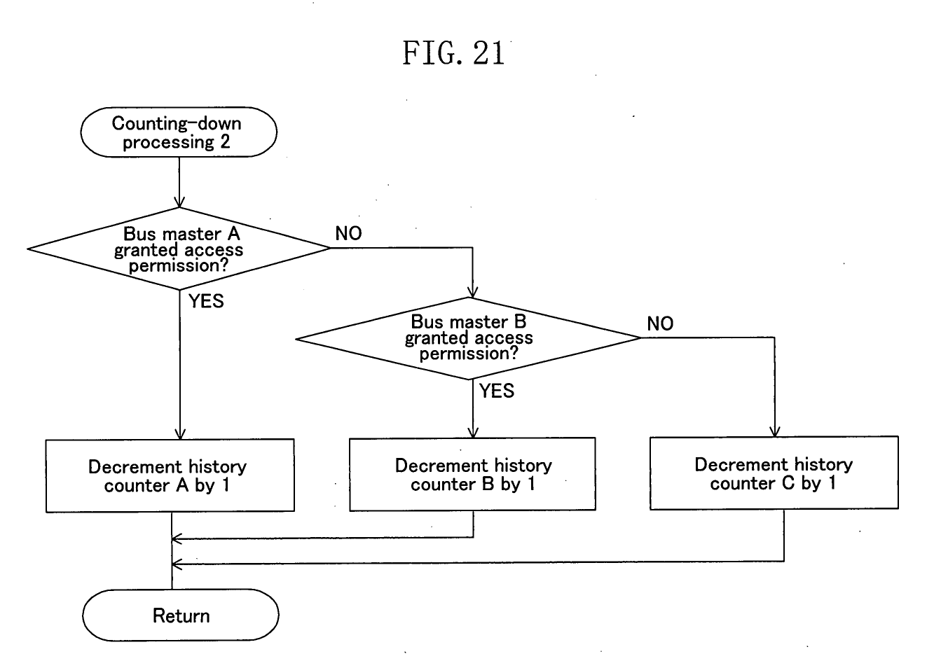

In the step 603 in FIG. 18, the arbitration timing generation block 202 determines whether or not there exists an access request from a bus master corresponding to a history counter that has not reached its lower limit notified by the history setting information management section 113. If no such access request exists, the process is terminated. If there exists such an access request, the process proceeds to step 307. In the step 307, as in the step 303, the arbitration timing generation block 202 generates the arbitration timing signal, to instruct the access request arbitration section 105 to execute arbitration. The process then proceeds to step 604. In the step 604, the history counters 204 to 206 are subjected to second counting-down processing. In the second counting-down processing, shown in FIG. 21 in detail, the value of the history counter for the bus master granted access permission is decremented by one, based on the signal from the access request arbitration section 105. The process is then terminated.

In this embodiment, since the upper and lower limits are set uniquely for the history counters 204 to 206 for the respective bus masters in the history setting information management section 113, generation of the arbitration timing signal can be controlled for each bus master. By setting so that the value of any history counter be kept from becoming negative, each of the bus masters A, B and C is prevented from being granted access permission by a number of times exceeding the number of times by which the highest priority is assigned to the bus master in the table in the arbitration information management section 107. This ensures accurate bandwidth guarantee. Otherwise, by permitting a negative value for the history counters 204 to 206 and setting their lower limits appropriately, the access latency can be improved while attaining bandwidth guarantee. One history counter may be allocated for one group composed of a plurality of bus masters.

In Embodiments 1 to 4 described above, three bus masters were shown. Actually, an arbitrary number of bus masters can be used. The buses can be in various forms. For example, multilayer buses may be used. In the case of a plurality of bus masters connected to one bus, the present invention is also applicable to arbitration among these bus masters.

Various configurations other than that in FIG. 2 can be adopted as the configuration of the arbitration information management section 107 considering bandwidth guarantee, such as a configuration of counting the number of times of arbitration done for each of the bus masters 100 to 102. Further, the incrementing and decrementing of the history counter in FIG. 4 may be reverse to each other, and the increment may be a value other than one.

As described above, the resource management device of the, present invention can improve the access efficiency and the access latency, and thus is suitably applicable to system LSI and the like.

What is claimed is:

1. A resource management device interposed between a plurality of masters and at least one shared resource, the device comprising:
an arbitration information management section for managing priority information of the masters as arbitration information;
an access request arbitration section for arbitrating access requests from the masters to the shared resource based on the arbitration information;
an arbitration timing control section for instructing the access request arbitration section to start arbitration;
a resource control section for controlling data transfer between a master granted access by the access request arbitration section and the shared resource; and
an arbitration history management section for managing a history of the arbitration status of the access request arbitration section as history information,
wherein the arbitration timing control section has a function of shifting the start timing of the arbitration by the access request arbitration section from basic arbitration timings with fixed time intervals based on the history information from the arbitration history management section.

2. The device of claim 1, wherein if an access request has been issued from one or more masters at a given basic arbitration timing, the arbitration timing control section instructs the access request arbitration section to start the arbitration according to the basic timing,
if no access permission is issued due to absence of an access request from any of the masters at a given basic arbitration timing, the arbitration timing control section instructs the arbitration history management section to hold permission postponing record as the history information, and
if an access request has been issued from one or more masters at an timing other than the basic arbitration timings and the arbitration history management section holds the permission postponing record, the arbitration timing control section shifts the start timing of the arbitration by the access request arbitration section from the basic timing so that access permission be issued to any of the one or more masters which have issued an access request without a wait for the next basic arbitration timing, and deletes the permission postponing record held by the arbitration history management section.

3. The device of claim 2, wherein the arbitration information management section holds priority information for each master at each of the basic arbitration timings in one period as the arbitration information, and has a function of initializing one or a plurality of permission postponing records accumulated in the arbitration history management section every time length not shorter than the one period.

4. The device of claim 2, further comprising a history setting information management section for setting a postponing upper limit so as to impose limitation on the accumulative number of permission postponing records.

5. The device of claim 4, wherein the history setting information management section receives a resource status signal indicating the status of the shared resource from the resource control section, and has a function of changing the setting of the postponing upper limit according to the status of the shared resource.

6. The device of claim 2, further comprising a history setting information management section for setting whether or not each of the plurality of masters is a master permitted to obtain access permission at an timing other than the basic arbitration timings.

7. The device of claim 1, wherein if an access request has been issued from one or 5 more masters at a given basic arbitration timing, the arbitration timing control section instructs the access request arbitration section to start the arbitration according to the basic timing,
if an access request has been issued from one or more masters at a timing other than the basic arbitration timings, the arbitration timing control section shifts the start timing of the arbitration by the access request arbitration section from the basic timing so that access permission be issued to any of the one or more masters which have issued an access request without a wait for the next basic arbitration timing, and instructs the arbitration history management section to hold permission advancing record as the history information, and
if no access permission is issued due to absence of an access request from any of the masters at a given basic arbitration timing, the arbitration timing control section deletes the permission advancing record held by the arbitration history management section.

8. The device of claim 7, wherein the arbitration information management section holds priority information for each master at each of the basic arbitration timings in one period as the arbitration information, and has a function of initializing one or a plurality of permission advancing records accumulated in the arbitration history management section every time length not shorter than the one period.

9. The device of claim 7, further comprising a history setting information management section for setting an advancing upper limit so as to impose limitation on the accumulative number of permission advancing records.

10. The device of claim 9, wherein the history setting information management section receives a resource status signal representing the status of the shared resource from the resource control section, and has a function of changing the setting of the advancing upper limit according to the status of the shared resource.

11. The device of claim 7, further comprising a history setting information management section for setting whether or not each of the plurality of masters is a master permitted to obtain access permission at a timing other than the basic arbitration timings.

12. The device of claim 1, wherein the arbitration history management section has a single history counter for managing the history information of the plurality of masters, and
if an access request has been issued from one or more masters at a given basic arbitration timing, the arbitration timing control section instructs the access request arbitration section to start the arbitration according to the basic timing,
if no access permission is issued due to absence of an access request from any of the masters at a given basic arbitration timing, and under the condition that the value of the history counter has not reached an upper limit, the arbitration timing control section increments the value of the history counter by one, and
if an access request has been issued from one or more masters at a timing other than the basic arbitration timings, and under the condition that the value of the history counter has not reached a lower limit, the arbitration timing control section shifts the start timing of the arbitration by the access request arbitration section from the basic timing so that access permission be issued to any of the one or more masters which have issued an access request without a wait for the next basic arbitration timing, and decrements the value of the history counter by one.

13. The device of claim 1, wherein the arbitration history management section has a plurality of history counters for managing the history information individually for the plurality of masters or for a plurality of master groups each composed of two or more masters among the plurality of masters, and
if no access permission is issued due to absence of an access request from any of the masters at a given basic arbitration timing, the arbitration timing control section increments the value of the history counter for a master having the highest priority at the given basic arbitration timing,
if an access request has been issued from one or more masters at a given basic arbitration timing, the arbitration timing control section instructs the access request arbitration section to start the arbitration according to the basic timing, and under the condition that a master having the highest priority at the given basic arbitration timing has been granted access permission by the access request arbitration section, decrements the value of the history counter by one for the master granted access permission, and
if an access request has been issued from one or more masters at a timing other than the basic arbitration timings and under the condition that the value of the history counter for the one or more master that have issued the access request has not reached a lower limit, the arbitration timing control section shifts the start timing of the arbitration by the access request arbitration section from the basic timing so that access permission be issued to any of the one or more masters satisfying the above condition without a wait for the next basic arbitration timing, and decrements the value of the history counter by one for the master granted access permission by the access request arbitration section.

14. A resource management method adopted in a system in which a plurality of masters issue access requests to at least one shared resource, the system comprising an access request arbitration section, a basic arbitration timing signal generation section, an arbitration timing generation section and a history counter, the method comprising the steps executed by the arbitration timing generation section of:
(1) determining whether or not the operating timing is a basic arbitration timing notified by the basic arbitration timing signal generation section;
(2) determining whether or not there exists an access request from one or more masters based on a signal from the access request arbitration section if the operating timing is determined to be a basic arbitration timing in the step (1);
(3) generating an arbitration timing signal to instruct the access request arbitration section to execute arbitration if it is determined that there exists an access request from one or more masters in the step (2);
(4) incrementing the value of the history counter by one so as to record lack of issuing access permission due to absence of an access request at the basic arbitration timing if it is determined that there exists no access request from any master in the step (2);
(5) determining whether or not there exists an access request from one or more masters based on the signal from the access request arbitration section if the operating timing is determined not to be a basic arbitration timing in the step (1), and terminating the process if it is determined that there exists no access request from any master;
(6) determining whether or not the value of the history counter is one or more to determine whether or not there is a basic arbitration timing at which no access permission has been issued if it is determined that there exists an access request from one or more masters in the step (5), and terminating the process if the value of the history counter is zero; and
(7) generating the arbitration timing signal so as to instruct the access request arbitration section to execute arbitration and decrementing the value of the history counter by one if the value of the history counter is one or more in the step (6).
